(19) United States
(12) Patent Application Publication
(10) Pub. No.: US 2008/0241953 A1
(43) Pub. Date: Oct. 2, 2008

(54) Method and Apparatus for Patterning a Bibulous Substrate

(75) Inventor: Falk Fish, Tel-Aviv (IL)

Correspondence Address: FOLEY HOAG, LLP;PATENT GROUP (w/ISA), 155 SEAPORT BLVD., BOSTON, MA, 02210-2600, US

(73) Assignee: Inverness Medical Switzerland GmbH, Zug (CH)

(21) Appl. No.: 12/065,780

(22) PCT Filed: Sep. 6, 2006
(86) PCT No.: PCT/IL2006/001037

§ 371 Date: Mar. 5, 2008

Related U.S. Application Data
(60) Provisional application No. 60/713,761, filed on Sep. 6, 2005.

(51) Int. Cl. G01N 21/78; B01J 19/00; B41F 1/00

(52) U.S. Cl. 436/169; 422/68.1; 101/287

(57) ABSTRACT

A method of patterning a bibulous substrate is disclosed. The method comprises contacting the bibulous substrate with a first surface being coated by a barrier compound, using a second surface having a predetermined pattern engraved thereon, and applying heat and pressure onto the first surface such as to pattern the bibulous substrate in a predetermined pattern.

### FIELD AND BACKGROUND OF THE INVENTION

The present invention relates to test devices and, more particularly, to an apparatus and method for patterning a bibulous substrate and to a test device having the bibulous substrate.

A variety of chemical and biochemical tests are conducted in or on a matrix of flat, bibulous support materials. Such supports typically include filter papers, membranes made of e.g., cellulose derivatives and glass fiber paper sheets. These supports are typically hydrophilic or made hydrophilic in order to facilitate loading and movement of the aqueous solutions and specimens involved in the assay. Due to the bibulous structure and hydrophilic properties, a drop of an aqueous solution placed on the surface of such a flat support tends to spread laterally in a radial fashion. The designer of matrix-based assays may wish to limit the radial spread of liquids and to direct their flow into a single dimension, either laterally, in parallel to the matrix, or vertically, into the matrix. One way of achieving directional movement is cutting the matrix in the shape of the required movement, such as a circle or a stripe, thus creating a barrier of air surrounding the matrix.

However, the cutting technique is limited in the sense that it increases the number of parts which have to be handled, for example, when multiple fluid paths are required, for example, for the purpose of conducting different parallel tests on the same sample, or on different samples. Such an approach is employed, for example, when testing bacterial isolates for their sensitivity to multiple antibiotic drugs.

Also known in the art are techniques in which barriers are created on the flat matrix without cutting. In one such technique, the matrix is impregnated with barrier materials, for example water-repellent materials, such as to form the required fluid path.

U.S. Pat. No. 4,790,979 discloses a test strip which can be used for analysis of whole blood, wherein a barrier layer is provided between a wicking layer and a porous membrane to preclude contact therebetween. However, this technique only prevents vertical migration of fluids while oftentimes it is desired to prevent lateral migration.

U.S. Pat. No. 5,571,684 teaches a technique for forming a radial migration barrier, by depositing a solution or suspension of a sample-impermeable material on the upper and lower surfaces of a panel in a defined geometric or iconic pattern and allowing the solution or suspension to penetrate the thickness of the panel. The solvent is then removed by evaporation. When the migration barrier solution or suspension is deposited in identical aligned patterned regions on both surfaces of the panel, each application penetrates slightly more than half the thickness of the panel. In this method, the solution or suspension of the barrier material is usually applied onto each surface of the panel by printing, spraying or brush application.

In another example, U.S. Pat. No. 5,124,266 teaches a test pad carrier matrix of a fibrous, bibulous substrate, such as filter paper, homogeneously impregnated with a polymerized urethane-based compound dispersed in a liquid vehicle comprising an aprotic solvent and an alcohol. This carrier matrix is shown to eliminate indicator reagent composition run-over onto adjacent test pads, in test strips used to assay more than one analyte.

U.S. Pat. No. 5,705,397 similarly teaches an analytical device comprising at least one liquid flow channel of porous material leading from a channel end to an analytical site via a localized reagent site, whereas a liquid-impermeable barrier is arranged adjacent to the reagent site in the liquid flowpath to slow the transport of the reagent to the analytical site.

However, the use of solvents for forming barriers is not desirable, due to cost, health and safety implications, and is particularly disadvantageous when organic solvents are employed. These concerns become yet more apparent in large scale industrial processes, wherein large amounts of solvents mean a higher flammability, environmental and toxicity risks, specialized high-cost equipment, and an increase in the total cost of the product.

An additional limitation of the methods described hereinabove is the evaporation of solvents, which results in large vapor amounts, and necessitates additional steps of collecting and disposing of the evaporated solvents, as well as additional equipment.

It is recognized that the use of solutions requires the barrier materials to be dissolved in an appropriate solvent prior to the application of the solution to the matrix. The need to match the suitable barrier compound to its solvent, requires further experimentation, and reduces the number of compounds which can be used as barrier compounds

Furthermore, the precise application of solutions or dispersions onto the bibulous substrate requires a time-consuming dispersion, and further necessitates employing a robotic fluid dispenser, which is less favored from the standpoint of cost, and availability.

Presently known techniques for creating barriers on bibulous substrate therefore suffer from high cost, complexity of operation, and additional safety hazards.

There is thus a widely recognized need for, and it would be highly advantageous to have, a method and apparatus for patterning a bibulous substrate, devoid of the above limitations.

### SUMMARY OF THE INVENTION

According to one aspect of the present invention there is provided a method of patterning a bibulous substrate. The method comprises contacting the bibulous substrate with a first surface being coated by a barrier compound; and using a second surface having a predetermined pattern engraved thereon for applying heat and pressure onto the first surface, such as to pattern the bibulous substrate in the predetermined pattern.

According to another aspect of the present invention there is provided an apparatus for patterning a bibulous substrate. The apparatus comprises a first surface coated by a barrier compound, a second surface having a predetermined pattern engraved thereon, and a heating and pressuring mechanism for applying heat and pressure onto the first surface.

According to yet another aspect of the present invention there is provided a bibulous substrate formed by the method described hereinabove.

According to an additional aspect of the present invention there is provided an analyte detection device. The device comprises the substrate and is capable of providing a detectable response being indicative to presence or level of an analyte in a fluid

According to further features in preferred embodiments of the invention described below, the response is a detectable color transition.

According to yet an additional aspect of the present invention there is provided a method of detecting presence or level of an analyte in a test fluid. The method comprises contacting the test fluid with the analyte detection device, and determining the response, thereby detecting presence or level of the analyte

According to further features in preferred embodiments of the invention described below, the determination comprises measuring.

According to still further features in the described preferred embodiments, the determination comprises quantitative measurement.

According to still further features in the described preferred embodiments, the determination comprises qualitative assessment.

According to still further features in the described preferred embodiments, the test fluid comprises a biological test fluid.

According to still another aspect of the present invention there is provided a device for controlling locomotion of a fluid. The devices comprises the substrate described hereinabove.

According to still another aspect of the present invention there is provided a method of controlling locomotion of fluids. The method comprises contacting the fluids with the device, thereby controlling the locomotion of the fluids.

According to a further aspect of the present invention there is provided a kit for detecting an analyte present in a test fluid. The kit comprises one or more analyte detection devices.

According to further features in preferred embodiments of the invention described below, the kit further comprises at least one additional component selected from the group comprising of a means for obtaining a physiological sample, a reference and/or standard solution, and instructions for use thereof.

According to further features in preferred embodiments of the invention described below, the heat is applied such that the temperature of the barrier compound is from about 80 degrees centigrade to about 300 degrees centigrade, more preferably from about 100 degrees centigrade to about 250 degrees centigrade.

According to still further features in the described preferred embodiments, heat and pressure are applied for a duration of less than 30 seconds, more preferably, from about 0.1 second to about 20 seconds, more preferably from about 1 second to about 10 seconds.

According to still further features in the described preferred embodiments, the bibulous substrate is a fibrous substrate.

According to still further features in the described preferred embodiments, the bibulous substrate is selected from the group comprising of paper, a woven material, a nonwoven material, a natural polymer, a synthetic polymer, a modified natural polymer, and any mixture thereof. Preferably, the paper is selected from the group consisting of filter paper, glass-fiber paper, woven and unwoven cloth. More preferably, the paper is a glass-fiber paper.

According to still further features in the described preferred embodiments, the barrier compound is hydrophobic. Preferably, the hydrophobic barrier compound is selected from the group comprising of paraffin, wax, oil, silicone compound, water-insoluble cellulose derivative, polyacrylate, polyester, polyamide, water-insoluble adhesive, hot melt adhesive, and radiation curable polymeric composition According to still further features in the described preferred embodiments, the bibulous substrate is hydrophilic.

According to still further features in the described preferred embodiments, the barrier compound is hydrophilic.

According to still further features in the described preferred embodiments, the bibulous substrate is hydrophobic.

According to still further features in the described preferred embodiments, the second surface is made of a metal or metal alloy.

According to still further features in the described preferred embodiments, the first surface is selected from the group comprising of a paper, a metal foil and a polymeric film. Preferably, the first surface comprises a paper.

The present invention successfully addresses the shortcomings of the presently known configurations by providing a method and apparatus for patterning a bibulous substrate which is safer, easier and faster to use and is less costly than the exiting methods. Further provided is the bibulous substrate patterned by the method and apparatus, the analytical device and/or device for controlling the flow of liquids which use this substrate, the corresponding methods of using these devices, and a kit comprising the patterned substrate.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

The term “comprising” means that other steps and ingredients that do not affect the final result can be added. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a,” “an,” and “the” include plural references unless the context clearly dictates otherwise. For example, the term “a compound” or “at least one compound” may include a plurality of compounds, including mixtures thereof.

As used herein, the term “substantially” generally refers to an arrangement of elements or features that, while in theory would be expected to exhibit exact correspondence or behavior, may in practice embody something slightly less than exact. As such, the term denotes the degree by which a quantitative value, measurement or other related representation may vary from a stated reference without resulting in a change in the basic function of the subject matter at issue.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “about” means ±10%.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A-D are images of various hydrophobic circle-shaped barriers dispersed on a bibulous substrate after being injected with colored water: castor oil (FIG. 1A), acrylic paint (FIG. 1B), glass paint (FIG. 1C) and nail lacquer (FIG. 1D);

FIG. 2A-C are images of bibulous substrate patterned by hot stamping after being injected with colored water: hot stamp only after 10 seconds (FIG. 2A), hot stamping with siliconized Kraft paper after 5 seconds (FIG. 2B), and hot stamping with siliconized Kraft paper after 1 second (FIG. 2C);

FIG. 3 is a flowchart diagram of a method suitable for a method of patterning a bibulous substrate, according to various exemplary embodiments of the present invention; and

FIG. 4 is a schematic illustration of an apparatus for patterning a bibulous substrate, according to various exemplary embodiments of the present invention.

### DESCRIPTION OF THE PREFERRED EMBODIMENTS

The present embodiments comprise a method and an apparatus which can be used for patterning substrates. Specifically, the present embodiments can be used to provide a barrier pattern on bibulous surfaces, and is suitable for a variety of substrates, including substrates made of crumbly materials, such as glass-fiber paper. The present embodiments further comprise a substrate patterned by the method and/or apparatus, a test device incorporating the substrate, and a method of using the test device, e.g., for the purpose of controlling locomotion of fluids and/or identifying analytes present in the fluids.

The principles and operation of a method and apparatus according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

As discussed hereinabove, bibulous and/or fibrous materials are often used as support matrices in chemical and biochemical tests. Thus, designing such support matrices while limiting and/or directing the spread of liquids in a specific dimension is often a necessity.

Over the years, this has been achieved either by cutting the matrix along a desired contour line, or by creating barriers on the flat matrix, so as to form the required fluid path.

Although creating barriers is a less limited method compared to cutting, the currently available technique for applying the barrier compounds onto bibulous materials is based on using solvent-based solutions or dispersions, wherein the barrier compounds are dissolved or dispersed, accordingly.

As is further discussed hereinabove, this technique is characterized by many practical disadvantages:
a) Health and safety concerns, resulting from the use of solvents, in particular organic solvents, which are often flammable, environmentally unfriendly and toxic. These concerns invariably also add to the cost of the process;
b) The additional steps and equipment associated with solvent evaporation, collection and disposal, add time, cost and complexity to the process;
c) Solvent use is limited to certain substrates, and is not suitable to others, such as crumbly substrates (for example glass-fiber paper);
d) In this method, using a certain barrier compound is limited by the need to find suitable solvents for this compound, as well as finding suitable solvation conditions; and
e) In order to apply solutions or dispersions in a precise manner, thereby forming the required barrier pattern, it is necessary to employ a robotic fluid dispenser, which is less favored from the standpoint of cost and availability.

Thus, a novel method and apparatus for patterning a barrier compound on a bibulous substrate, devoid of the above limitations, are highly desirable.

While conceiving the present invention, it was hypothesized that bibulous substrates can be efficiently and economically patterned by a hot stamping technique.

Hot stamping, otherwise known as hot-foil printing, is a dry print method with which a motive, such as a pigmented color or metallized surface, is transferred to a surface by pressure, temperature and time. The ability to press metal sheets onto paper, which is one of the principles of this method, has itself been known for decades. As of the beginning of the 20^{th} century, electricity and heat were introduced into the process, and hot stamping has become the efficient, inexpensive method to apply decorations to thermoplastic materials.

This technique has been used for the decoration and/or labeling of a variety of plastic, metal, and printed matter. However, heretofore, hot printing has not been applied onto fibrous or bibulous substrate probably due to its delicate structure.

It has now been surprisingly found that hot stamping can be successfully applied on bibulous substrates, so as to pattern the substrates with a barrier compound, using surfaces coated by suitable barrier materials.

As demonstrated in the Examples section below, the method of the present embodiments successfully patterns, for instance, water-repellant circles on a glass-fiber paper, by hot stamping a siliconized paper on a standard glass-fiber absorbent pad. The obtained silicone barriers are substantially impermeable to water-based reagents.

The present embodiments therefore successfully address the shortcomings of the presently known configurations by providing a method of patterning barrier compounds onto bibulous substrates, which altogether circumvents solvent use.

Before providing a further detailed description of the method and apparatus for patterning substrates, as delineated hereinabove and in accordance with the present embodiments, attention will be given to the advantages and potential applications offered thereby:
a) The flammability and toxicity of organic solvents is avoided;
b) The method is fast and of low-cost;
c) The method is applicable to a large variety of substrates, including crumbly substrates, such as glass fibers;
d) The method is applicable to a large variety of barrier compounds; and
e) Precise application is easily achieved by heat pressing a pre-engraved stamp, enabling even the formation of elaborate patterns, otherwise difficult or impossible by the solution deposition method.

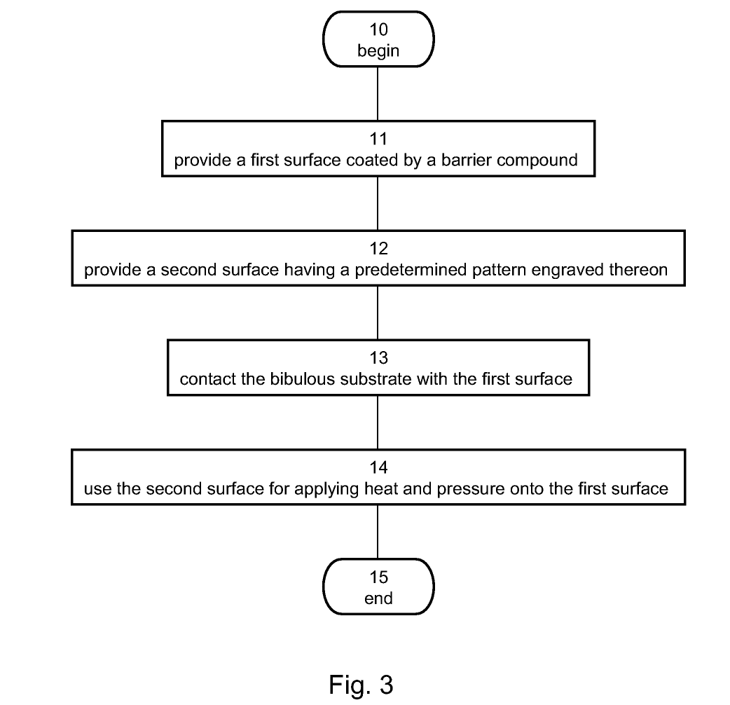

Reference is now made to FIG. 3, which is a flowchart diagram of a method suitable for patterning a bibulous substrate, according to various exemplary embodiments of the present invention. It is to be understood that, unless otherwise defined, the method steps described hereinbelow can be executed either contemporaneously or sequentially in many combinations or orders of execution. Specifically, the ordering of the flowchart diagrams is not to be considered as limiting. For example, two or more method steps, appearing in the following description or in the flowchart diagrams in a particular order, can be executed in a different order (e.g., a reverse order) or substantially contemporaneously. Additionally, several method steps described below are optional and may not be executed.

The method begins at step 10 and optionally and preferably continues to step 11, in which a first surface coated by a barrier compound is provided. The first surface is any surface which is suitably coated by a barrier compound. Representative examples include, without limitation, a paper, a metal foil and a polymeric film.

The term “paper” refers to a web structure which contains cellulose and optionally other additives.

The term “foil” or “metal foil” refers to a thin sheet of metal. A metal foil is most easily prepared from malleable metals, such as, but not limited to, aluminum, copper, nickel, zinc, tin and gold.

The term “film” or “polymeric film” refers to a thin coating or layer of a plastic or polymeric material.

The method, optionally and preferably proceeds to step 12, in which a second surface having a predetermined pattern engraved thereon is provided. The second surface is preferably made of a metal or a metal alloy. Representative examples include, without limitation, aluminum, copper, iron, zinc, and combinations thereof. Each metal listed includes both the elemental metal and alloys thereof. Preferred metals, include, without limitation, brass, an alloy of zinc and copper. In various exemplary embodiments of the invention the second surface is a surface of a metal block, otherwise known as “mold”, “die” or “stamp”. The pattern engraved on the second substrate can be of any geometrical shape or figure as further detailed hereinunder, and can be engraved using any procedure known in the art.

The method continues to step 13, in which a bibulous substrate is contacted with the first surface.

The term “bibulous” or “bibulous substrate” refers to any absorbent material characterized by preferential retention of one or more components, as is present in chromatographic separations. Examples of bibulous materials include, but are not limited to, nylon, untreated forms of paper, and nitrocellulose.

The term “substrate” refers to any supporting structure.

According to a preferred embodiment of the present invention, the bibulous substrate may be a fibrous substrate.

The term “fibrous” or “fibrous substrate” refers to any compound comprised of fibers, and includes, but is not limited to, cellulosic fibers; yarns; woven, knitted or nonwoven fabrics and textiles; and finished goods.

Once a contact is established between the surface and the substrate, the method continues to step 14, in which the second surface is used for applying heat and pressure onto the first surface, such as to pattern the bibulous substrate in the predetermined pattern.

The method ends at step 15.

Herein, the term “patterning” refers to a process wherein a specific design or pattern is projected onto a surface. The pattern may assume any geometric shape, such as, but not limited to, a line, a circle, an ellipse, a rectangle, a square or any shape formed of a combination of curved or straight lines. The pattern can be chosen according to the specific use, for example, a test strip of a particular use. Thus the pattern can assume the shape of characters (e.g. in blood typing), numbers (patient number), and the like.

The bibulous substrate is preferably selected from the group comprising of paper, woven material, nonwoven material, natural polymers, synthetic polymers, modified natural polymers and mixtures thereof. Any paper, metal foil or film which withstands the heat of the hot stamp can be used. Representative example includes, without limitation, Kraft paper.

The phrase “woven material” refers to a material, such as cloth or fabric, made by a weaving process. Examples include, but are not limited to, braided materials, knitted materials and loom woven materials. Preferably, the woven material include fabrics formed of ceramic fibers, such as fiber glass, ceramic fibers, graphite fibers, carbon fibers, quartz fibers or woven mixtures of these materials.

The phrase “nonwoven material” refers to a material, such as cloth or fabric, having a porous sheet structure, whereas the sheets are bound by forces such as friction, cohesion, or adhesion, which are not a result of a weaving process. Examples include, but are not limited to, natural fibers, such as cellulose or cotton, or of synthetic fibers, such as polyethylene, polypropylene, polyester, polyurethane, nylon, or regenerated cellulose.

The phrase “natural polymers” refers to polymers which are found in and obtained from natural substances. Examples include, without limitation, starch, xanthan gums, cellulose, polysaccharides and the like. The phrase “modified natural polymers” refers to such polymers which were chemically modified by, for example, oxidation/reduction, substitution, etc.

The present invention is suitable in particular to substrates which are used in preparation of test devices, mainly forms of paper, such as filter paper and glass-fiber paper.

A filter paper is a porous coarse unfinished paper which is used in the separation of solids from a liquid in which they are suspended.

Glass-fiber paper is a filter medium of the depth type consisting of non-woven glass fibers which are assembled together by a pressure process only, or with addition of polymers, which provide adhesion and stability. Glass fiber paper, which is mainly used in filtration of liquids for removal of particulate matter from them and in analytical procedure in various fields of science, including biology, where particles of interest are collected from suspension and analyzed for their composition. One glass-fiber material, which is also described in WO 05/003787, is grade 142 made by Ahlstrom Filtration, Mt. Holly Springs, Pa., USA. Other types and grades of glass fiber media are available from Ahlstrom as well other suppliers of filtration media, such as, but not limited to, Whatman and Millipore.

Due to its special uses, glass-fiber paper is most suitable as a substrate. However, since it is a crumbly material, it cannot be treated with printing technologies. Thus, depositing barrier compounds by printing is not applicable, and in order to pattern it, cutting is the most often sought solution. Unfortunately, this limits the use of the substrate to small, one directional test strips. If multi-sample strips or radial strips are needed, an alternative way is required. The novel method disclosed herein offers an alternative route to patterning this kind of structure.

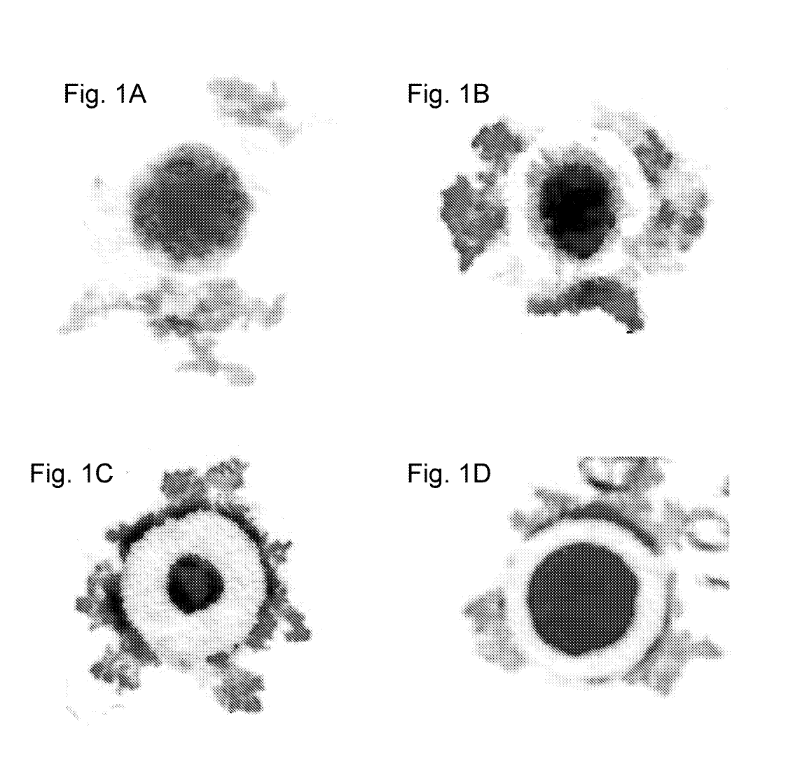

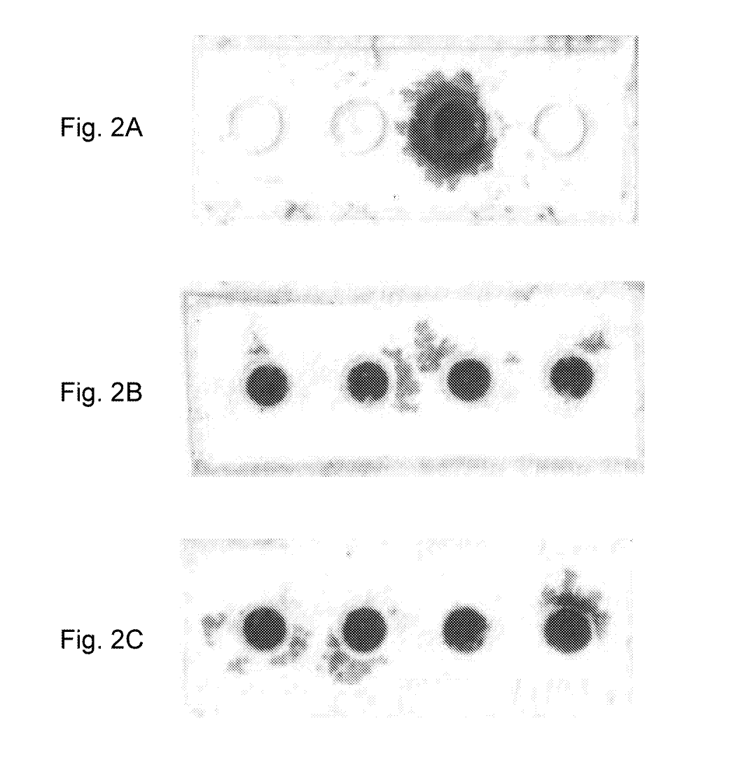

Indeed, as shown in the Examples section below, glass-fiber paper treated with conventional suspensions (FIG. 1A-D) exhibited leaking of the inner colored solution, and oftentimes an uneven distribution of the regent within the barrier, was observed (FIG. 1C). Airbrushing has also proven to be very inaccurate and required multiple dilutions in water rendering it ineffective. In contrast, applying the present method on the same paper created a clear boundary, not only after a relatively prolonged pressure (about 5 seconds, see FIG. 2B), but even when the stamping process was short (about 1 second, FIG. 2C).

As explained hereinabove, it is oftentimes necessary to conduct multiple testing on a single substrate, or it is necessary for other reasons to direct the liquid flow within a bibulous and/or fibrous substrate, and to avoid inter-contamination or liquid sample loss. This is frequently avoided by depositing barrier compounds onto the substrate, the geometry of which is determined according to the application.

The term “barrier compound” refers to any compound selectively impermeable to a certain liquid type. It is easily determined by the user, according to the test device and the substrate. More specifically, the reagent may be either water-based (for example in the testing of body fluids etc.) or water-repellant (for example in testing oils. Accordingly, the bibulous substrate is either hydrophobic (water repellant) or hydrophilic (water-based). In order to prevent the passing of the reagent beyond the barrier material, the barrier compound can be either hydrophobic or hydrophilic. Preferentially, but not obligatorily, there is a relationship between the barrier compound and the bibulous substrate, such that when the bibulous substrate is hydrophilic, the barrier compound is hydrophobic, and when the bibulous substrate is hydrophobic, the barrier compound is hydrophilic.

In biological applications, the former case is the prevailing one, and therefore hydrophobic barriers are often sought for.

Examples of hydrophobic barrier compounds include, but are not limited to, paraffins, waxes, oils, water-insoluble (e.g., hydrophobic) cellulose derivatives, polyacrylates, polyesters, polyamide derivatives, water-insoluble adhesives, silicone compounds, hot melt adhesives, and radiation curable polymeric compositions.

The term “waxes” refers to solid or semisolid pliable, water insoluble, materials derived from various plant, animal and petroleum distillates or residues, which consist of a mixture of solid hydrocarbons. Petroleum wax is termed: paraffin.

The term “paraffins” is a common name of a family of saturated hydrocarbons derived from petroleum.

The term “oils” refers to aggregates of unsaturated fats or a mixture of saturated and unsaturated fats, which are usually liquid and often viscous at room temperature.

The term “silicone compounds” refers to compounds obtained by the polymerization of a silicone-containing monomer unit such as, but not limited to, a chlorosilane, an ester silicate, an alkoxysilane or a silanol.

The term “cellulose derivatives” encompasses compounds containing a cellulose moiety, as well as modified cellulose, as defined herein. Preferably, cellulose derivatives that are suitable for use in this context of the present embodiments include cellulose which has been modified so as to substitute at least a portion of the free hydroxyl groups thereof with hydrophobic moieties such as alkoxides, fatty acyls and the like.

The term “polyacrylates” refers to polymers or resins resulting from the polymerization of one or more acrylates, including, but not limited to, methyl acrylate, ethyl acrylate, butyl acrylate, 2-ethylhexyl acrylate, etc. This term also includes the term “polymethacrylates” which refers to polymers or resins resulting from the polymerization of one or more methacrylates, including, but not limited to, methyl methacrylate, ethyl methacrylate, butyl methacrylate, hexyl methacrylate, etc. Copolymers of the above acrylate and methacrylate monomers are also included. Polymers and copolymers derived from derivatives of the above monomers (e.g., substituted monomers, cyanoacrylates, acrylamides and the like) are also included.

The term “polyesters” generally refers to any ester group-containing polymer and includes both saturated and unsaturated polyesters. Preferably this term refers to synthetic fibers derived from polyester polymers. Polyesters are often derived from hydroxyl-containing and carboxylic acid-containing monomers which are subjected to condensation polymerization.

The term “polyamide derivative” refers to a polymer containing monomers joined by amide (peptide) bonds. This term includes, but is not limited to, natural polyamides such as wool and silk, and synthetic polyamides, such as Nylon and Kevlar. Polyeamides are often derived from amine-containing and carboxylic acid-containing monomers which are subjected to condensation polymerization.

The term “adhesive” refers to any material that can be utilized for attaching substrates to one another by surface attachment. Such bonding may result from the application of a pressure force, in the case of a pressure sensitive adhesive material, or a sufficiently high temperature, in the case of a hot-melt adhesive.

The term “water-insoluble adhesive” refers to adhesives which are substantially non-soluble in water and are hence water-resistant.

The term “hot melt adhesive” refers to a thermoplastic adhesive which is solid at room temperatures and becomes fluid when heated to melting.

The term “radiation curable polymeric composition” refers to polymer-containing compositions which are cured (e.g., by cross-linking) upon radiation.

Preferred hydrophobic barrier compounds are silicone compounds and paraffins.

Surfaces coated by any of the above barrier compounds are easily obtained in the market, and a wide variety of ready-to-use coated surfaces, are available for almost any purpose. An exemplary coated surface used in the experiments below is a siliconized paper by Kraft.

The current method is advantageous to the previous solvent-based method in that it is more precise, faster and less costly. Furthermore, it has an additional advantage in that any shape can be easily patterned, including simple geometrical shapes (e.g., circles, ellipses, rectangles, etc.) and more complicated shapes. For example, reagent area can be patterned with the shape of characters, digits or symbols (e.g., “A”, “B”, “5”, “+”) so as to simplify the interpretation of the results. Furthermore, hot stamping is less cumbersome and cheaper than the robotic auto dispensers used in conventional barrier patterning methods.

Thus, according to the method described herein, the bibulous substrate is contacted with the first surface, whereas the second surface is used for applying heat and pressure onto the first surface, thereby transferring the above-described predetermined pattern onto the bibulous substrate.

In practice, it is necessary that the barrier-coated side of the first surface faces the bibulous substrate, and at the same time, the second surface is pressed against the first surface, while heating, over time. With an appropriate selection of the pressure, temperature, duration of pressing and duration of heating, the barrier material applied to the surfaces penetrates the substrate hence forms the predetermined pattern thereon.

The heat is determined according to the boiling point of the barrier compound. Typically, but not obligatorily, the temperature ranges from about 80° C. to about 300° C., preferably from about 100° C. to about 250° C. The amount of heat applied is thus selected such that the temperature of the barrier compound is within the above ranges. Typical, heating power is from about 50 Watts to about 500 Watts.

The heat and pressure are preferably applied for a duration selected to allow patterning the substrate while not damaging its properties. Yet, some hot stamping marks may appear on the patterned substrate. In various exemplary embodiments of the invention the duration is less than 30 seconds, more preferably from about 0.1 second to about 20 seconds, more preferably from about 1 second to about 10 seconds. As exemplified in the Examples section that follows, the method described herein was tested in a 10-fold time range, and has proven to be effective even at relatively short pressing times (see FIG. 2C). Application of hot pressing without the coated barrier surface, even for a long time, was not effective in itself (see FIG. 2A), and did not result in a water impermeable boundary.

As shown in the Examples section that follows, glass fiber paper patterned with silicone-based barriers exhibited a clear boundary, and impermeability to the water-based solution (see FIGS. 2B-C).

It should be further noted that using less heat and/or less time applying this heat are preferred from the standpoint of time and production cost, and such heat and/or time values are also encompassed by the present invention, provided the barrier material is successfully stamped on the substrate.

Higher heat and/or longer time frames than those listed above are generally not preferred, and may result in damage to the substrate. However, it may be envisioned that higher heat is applied for a short period of time, or that low heat is applied for a relatively long time, as long as the barrier material is securely stamped on the substrate, and the substrate is not damaged (e.g., is not burned or torn).

The experimental results presented in the Examples section that follows indicate that the method of the present embodiments, is fast and effective, devoid of the limitations of the presently known solvent-based methods, and is advantageously characterized by avoiding the use of flammable, toxic solvents, speed and of low-cost, applicability to a large variety of substrates, including crumbly substrates, applicability to a large variety of barrier compounds, precision, and the ability to form even elaborate patterns, in a simple-to-use manner.

As discussed hereinabove, bibulous and/or fibrous materials are often used as support matrices in chemical and biochemical tests, where the limitation or direction of the radial spread of liquids, discussed hereinabove, is required.

The bibulous substrate prepared according to various exemplary embodiments of the present invention is characterized by a predetermined barrier pattern stamped thereon, and can selectively control the locomotion of fluid thereon. For example, as demonstrated in the Examples section that follows, a water-based liquid was substantially maintained within a circle-shaped hydrophobic barrier, prepared according to the method described hereinabove (FIGS. 2B-C). The substrate of the present embodiments is advantageous in that it exhibits the required barrier properties, while having a lower cost of production, and thus a lower market price. Furthermore, it is advantageous that any shape can be easily patterned on this surface, a useful property in the manufacture of analytical devices. As further demonstrated in the Examples section which follows, a substrate prepared according to embodiments of the present invention, is easily recognizable by the hot stamping marks thereon.

The bibulous substrate can be incorporated in a device for controlling locomotion of a fluid. In use, such device can be contacted by the fluid, and the fluid can be allowed to migrate along the pattern impregnated on the substrate.

The substrate obtained by the method of the present embodiments, can also be incorporated in an analyte detection device capable of providing a detectable response being indicative to presence or level of an analyte in a fluid.

The term “analyte” refers to a compound or composition to be detected or measured in a sample.

The term “sample” refers to any desired material for sampling, usually of biological origin.

The analyte can be any specific substance or component that its detection and/or quantification in a chemical, physical, enzymatic, or optical analysis is desired. Exemplary analytes include, but are not limited to, antigens (such as antigens specific to bacterial, viral or protozoan organisms); antibodies, including those induced in response to an infection, allergic reaction, or vaccine; hormones, proteins and other physiological substances; nucleic acids; enzymes; therapeutic compounds and illicit drugs; contaminants and environmental pollutants, such as in detection of biological and/or chemical warfare, or hazardous solvents or reagents.

In use, a fluid sample is first contacted with the patterned substrate and thereafter the substrate is examined to determine the response of the device to the fluid sample. The device is designed and configured such that the response is indicative to the analyte in the fluid, thereby allowing detecting presence or level of the analyte.

The determination of the response can be achieved by performing a measurement, such as a quantitative measurement, a qualitative assessment, as known in the art. For example, the response can be a detectable color transition, in which case the determination of the response can be performed by manually or via spectral analysis.

As would be realized by any person skilled in the art, the number of natural and synthetic substances which can be detected by the assay devices and methods of the present invention is extensive. The device, according to the present embodiments is particularly useful for detection of analytes in samples of biological origins, and the term “test fluid” preferably refers to a biological test fluid. Such samples include, but are not limited to, blood or serum; saliva, sputum, tears, sweat, or other secreted fluids; urine or fecal matter; as well as biologically derived fluids such as cerebrospinal fluid, interstitial fluid, cellular extracts and the like. A volume of sample to be used for the assay device can be easily determined by a person skilled in the art.

Patterned substrate prepared according to the present embodiments can also be incorporated in a kit for use in detection or identification of analytes in fluids. The detection may comprise measurement of antigens on cells, and includes both quantitative and qualitative measurements.

The kit can comprise at least one analyte detection device, and may further comprise additional components, such as a means for obtaining a physiological sample, a reference or standard solution and instructions for using the components of the kit. These instructions may be recorded on a suitable recording medium, either printed, as a computer readable storage medium, or as a reference for obtaining the instructions.

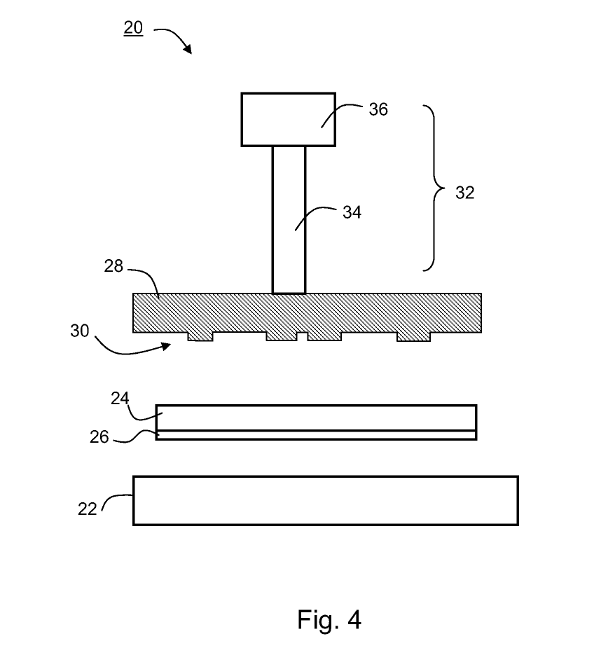

Reference is now made to FIG. 4 which is a schematic illustration of an apparatus 20 for patterning a bibulous substrate 22. Apparatus 20 can be used for executing selected steps of the method described hereinabove.

In various exemplary embodiments of the invention apparatus 20 comprises a first surface 24 coated by a barrier compound 26, as further detailed hereinabove. Apparatus 20 further comprises a second surface 28 having a predetermined pattern 30 engraved thereon, as further detailed hereinabove. Apparatus 20 further comprises a heating and pressuring mechanism 32 which applies heat and pressure onto surface 28. Mechanism 32 can be, for example, a thermally conducting rod 34 connected to a heat source 36.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Reference is now made to the following examples, which together with the above descriptions, illustrate the invention in a non limiting fashion.

### Materials and Methods

DoubleCheck absorbent pad was obtained from Filtrona Fibertec, Colonial Heights, Va.

The term “absorbent pad” refers to an absorbent or bibulous material usually positioned at the base of the assay device.

Glass-fiber paper, grade 142, was obtained from Ahlstrom Filtration, Mt. Holly Springs, Pa., USA.

Siliconized or paraffin coated papers and films were obtained from several suppliers of release liners for adhesive coated films, such as Loparex Inc., Willowbrook, Ill., USA.

Nail lacquer, castor oil, acrylic color and solvent based glass paint were obtained from common manufacturers.

Titanium White Acrylic white paint was obtained from Winsor & Newton, London, UK and diluted in water.

Paint spraying was conducted with a Paasche type F#1 airbrush (Harwood Heights, Ill., USA).

Images were captured using a CanoScan N670U scanner (Canon, Japan).

### Preparation of Patterned Bibulous Materials by Dispersion

Control samples were prepared by dispersing various hydrophobic barrier materials, such as nail lacquer, castor oil, acrylic color and solvent based glass paint, onto a bibulous substrate. Only the acrylic color was diluted with water. The other barrier materials were used without dilution.

The dispersion was conducted using an Asymtek DispenseMate® automated fluid dispensing systems. The dispenser was programmed to create 10 mm diameter circles, and materials were dispensed from a syringe having a 21G needle. The dispensing was conducted at 10 mm/sec, and under various pressures, as appears in Table 1 below:

TABLE 1

| Material | Pressure (psi) |
|---|---|
| Nail lacquer | 0 |
| Castor oil | 50 |
| Acrylic color | 5 |
| Glass Paint | 6 |

### Preparation of Patterned Bibulous Materials by Airbrushing

Diluted acrylic color was dispensed with an airbrush. Multiple dilutions (up to 1:20) in water were necessary.

### Preparation of a Hot Stamp

Hot stamping was conducted using a hot-stamping device. A brass stamp, featuring 4 circles of 5 mm diameter on a 20×50 mm rectangle, was engraved with the contours of the required fluid barrier by Askal Art Engraving (Bnei Brak, Israel) and attached to a 200 W hot stamping handle.

### Preparation of Patterned Bibulous Materials by Hot Stamping

An Ahlstrom 142 fiber-glass paper was used as a bibulous substrate. A hot stamp, engraved as described hereinabove, was first applied directly on the fiber-glass paper as a reference application, and pressure was maintained for about 10 seconds.

Then, the process was repeated by placing a siliconized paper between the surface of the bibulous substrate and the hot stamp, such that the silicone coated side of the siliconized paper was facing the substrate, for 1-10 seconds. The hot stamp and the siliconized paper were manually removed from the bibulous material, so as to provide a bibulous material patterned with the required barrier material.

The obtained patterned substrates were clearly distinguishable due to the hot stamping marks thereon.

### Testing the Impermeability of the Patterned Barriers

The impermeability of various hydrophobic barrier materials patterned on a bibulous substrate was tested by delivering 50-75 μL of water with green or red food coloring in the center of a tested circle-shaped barrier, and observing the barrier quality and the distribution within the circle.

### Experimental Results

The effectiveness of various hydrophobic materials as dispersed barriers is depicted in FIG. 1(A-D). As shown, nail lacquer (FIG. 1D) and acrylic paint (FIG. 1B) were better barriers than castor oil (FIG. 1A) and glass paint (FIG. 1C), but all exhibited leaking of the inner colored solution, as can be seen in FIGS. 1A-D. In addition, it was found that although the glass paint seemed to create a strong barrier, the distribution inside the circle was not even.

Airbrushing has proven to be very inaccurate and required multiple dilutions in water, rendering it ineffective.

Direct application of the hot stamp to the substrate paper, even under prolonged pressure (about 10 seconds, FIG. 2A), did not result in a water impermeable boundary. However, placing a siliconized paper between the substrate paper and the hot stamp, created a clear boundary, not only after a prolonged pressure (of after 5 seconds, FIG. 2B), but even when the stamping process was short (about 1 second, FIG. 2C).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A method of patterning a bibulous substrate, comprising:
contacting the bibulous substrate with a first surface being coated by a barrier compound; and
using a second surface having a predetermined pattern engraved thereon for applying heat and pressure onto said first surface, such as to pattern the bibulous substrate in said predetermined pattern.

2. Apparatus for patterning a bibulous substrate, comprising:
a first surface coated by a barrier compound;
a second surface having a predetermined pattern engraved thereon; and
a heating and pressuring mechanism for applying heat and pressure onto said first surface.

3. A bibulous substrate formed by the method of claim 1.

4. A device for controlling locomotion of a fluid, comprising the substrate of claim 3.

5. An analyte detection device comprising the substrate of claim 3, the analyte detection device being capable of providing a detectable response which is indicative to presence or level of an analyte in a fluid.

6. A method of detecting presence or level of an analyte in a test fluid comprising contacting the test fluid with the analyte detection device of claim 5, and determining said response, thereby detecting presence or level of the analyte.

7. The method of claim 6, wherein said determining comprises measuring.

8. The method of claim 6, wherein said determining comprises quantitative measurement.

9. The method of claim 6, wherein said determining comprises qualitative assessment.

10. The method of claim 5, wherein said response is a detectable color transition.

11. The method of claim 6, wherein said test fluid comprises a biological test fluid.

12. A method of controlling locomotion of fluids, comprising contacting the fluids with the device of claim 4, thereby controlling the locomotion of the fluids.

13. A kit for detecting an analyte present in a test fluid, the kit comprising at least one analyte detection device of claim 5.

14. The kit of claim 13 further comprising at least one additional component selected from the group comprising of a means for obtaining a physiological sample, a reference and/or standard solution, and instructions for use thereof.

15. The method of claim 1, wherein said heat is applied such that the temperature of said barrier compound is from about 80 degrees centigrade to about 300 degrees centigrade.

16. The method of claim 1, wherein said heat is applied such that the temperature of said barrier compound is from about 100 degrees centigrade to about 250 degrees centigrade.

17. The method of claim 1, wherein said heat and pressure are applied for a duration of less than 30 seconds.

18. The method of claim 1, wherein said heat and pressure are applied for a duration of from about 0.1 seconds to about 20 seconds.

19. The method of claim 1, wherein said heat and pressure are applied for a duration of from about 1 second to about 10 seconds.

20. The method of claim 1, wherein the bibulous substrate is a fibrous substrate.

21. The method of claim 1, wherein the bibulous substrate is selected from the group comprising of paper, a woven material, a nonwoven material, a natural polymer, a synthetic polymer, a modified natural polymer, and any mixture thereof.

22. The method of claim 1, said paper is selected from the group consisting of filter paper, glass-fiber paper, woven and unwoven cloth.

23. The method of claim 22, wherein said paper is a glass-fiber paper.

24. The method of claim 1, wherein said barrier compound is hydrophobic.

25. The method of claim 1, wherein the bibulous substrate is hydrophilic.

26. The method of claim 24, wherein said hydrophobic barrier compound is selected from the group comprising of paraffin, wax, oil, silicone compound, water-insoluble cellulose derivative, polyacrylate, polyester, polyamide, water-insoluble adhesive, hot melt adhesive, and radiation curable polymeric composition.

27. The method of claim 1, wherein said barrier compound is hydrophilic.

28. The method of claim 1, wherein the bibulous substrate is hydrophobic.

29. The method of claim 1, wherein said second surface is made of a metal or metal alloy.

30. The method of claim 1, wherein said first surface is selected from the group comprising of a paper, a metal foil and a polymeric film.

31. The method of claim 1, wherein said first surface comprises a paper.
